(19) United States
(12) Patent Application Publication
(10) Pub. No.: US 2008/0011571 A1
(43) Pub. Date: Jan. 17, 2008

(54) Force-Transmitting Assembly

(75) Inventors: Eckart Gold, Hockenheim (DE); Rainer Gerathewohl, Karlsruhe (DE)

Correspondence Address: WARN, HOFFMANN, MILLER & OZGA, P.C., P.O. BOX 70098, ROCHESTER HILLS, MI, 48307, US

(73) Assignee: BorgWarner Inc., Auburn Hills, MN (US)

(21) Appl. No.: 11/587,069

(22) PCT Filed: Apr. 18, 2005
(86) PCT No.: PCT/EP05/04094

§ 371 Date: Aug. 6, 2007

(30) Foreign Application Priority Data
Apr. 21, 2004 (EP) 04009398.1

(51) Int. Cl. F16F 15/10; F16D 23/00

(52) U.S. Cl. 192/30 V

(57) ABSTRACT

The invention relates to a multi-component force-transmitting unit, particularly a double-disk clutch, preferably comprising a torsional vibration damper. The inventive force-transmitting unit is wherein at least two components are axially preloaded against each other by means of at least one waived retaining ring.

The invention relates to a force-transmitting assembly as generically defined by the preamble to claim 1.

From EP 1,382,872 A1, a driver unit for force-transmitting assemblies is known. Such a driver unit is used in particular, but not exclusively, for driving or power takeoff connection of multi-disk clutch assembly systems in double-clutch assemblies.

The driver units known from the prior art essentially comprise a driving disk and a disk holder. In EP 1,382,872 A1, a positive-engagement combination of a driving disk and an outer disk holder is shown. However, it is also conceivable for an inner disk holder to be connected by positive engagement on the driving or power takeoff side by means of a driving disk. For producing a positive-engagement connection between the driving disk and the disk holder, it is known from the prior art to provide the driving disk with a circumferentially extending outer toothing. On the disk holder, an inner toothing is provided that in at least some portions is complementary in shape and function to the outer toothing of the driving disk. For installation of the driver unit, the driving disk with the outer toothing is inserted into the inner toothing of the disk holder.

The positive-engagement connection between the driving disk and the disk holder typically involves play, both for installation reasons and for the sake of economical production. As a result, increased wear occurs, especially from swaging of the connection of the driving disk and the disk holder. Another disadvantage is that noise develops during idling because of the positive-engagement connection that involves play.

The disadvantages can be overcome by a play-free connection between the driving disk and the outer disk holder. Freedom from play cannot be assured in every case, however, since play in the positive-engagement connection can occur in operation from wear, unfavorable tolerance conditions, and so forth. Particularly as a result of installing the clutch with the driving disk between the transmission and the motor in the drive train of a vehicle, a bending moment (rotational bending) can be conducted to the clutch via the driving disk as a result of radial errors of alignment between the input shaft of the transmission and the crankshaft of the internal combustion engine. As a consequence, the driving disk might move axially relative to the outer disk holder, inside the positive-engagement connection.

From EP 1,496,287 A1, a force-transmitting assembly of this generic type is known. In the known force-transmitting assembly, a half-shell of a torsional vibration damper is joined axially to a further component of the force-transmitting assembly. For this purpose, a flat retaining ring is provided, which is located inside a retaining ring groove and is braced on one side on a groove wall and on the other on the half-shell and thus presses the half-shell axially firmly against the further component. In force-transmitting assemblies, there are many such connections, or similar axial connections, of at least two components with the aid of a retaining ring. The retaining rings must be designed to fit precisely, among other reasons because of compensation for tolerances, reducing play or reducing noise. Thus, for each individual case, many retaining rings with finely graduated widths must be kept on hand, which must then be selected with the correct width and modified to suit the particular dimensions of the resultant installation space. In principle, because of these problems, absolute freedom from play cannot be achieved, since for reasons of logistics and handling, it is not possible to keep every conceivable width on hand.

With this prior art as the point of departure, the object of the present invention is to propose a force-transmitting assembly in which at least two components can be joined to one another axially without play.

This object is attained by the characteristics of claim 1.

Advantageous features of the invention are recited in the dependent claims.

The invention is based on the concept, at least in the axial joining of two components of a clutch assembly, of replacing the previously usual flat retaining ring with a retaining ring that is waved and hence embodied resiliently, particularly in the circumferential direction. By the use of a waved retaining ring, the components to be joined are braced against one another in the axial direction. Since the waved retaining ring is capable of adapting to the available installation space within certain limits, a play-free axial connection is assured.

By means of the embodiment of the force-transmitting assembly according to the invention, not only is a play-free connection furnished, but many other advantages are also attained, such as simpler logistics, a smaller inventory, and reduced costs.

The use of a waved retaining ring for producing a play-free axial connection is especially advantageous in the following fields:
Axial fixation of a torsional vibration damper to a component of the force-transmitting assembly, in particular to a housing of the force-transmitting assembly
Attaching disk holders, in particular multi-part disk holders, to a component of the force-transmitting assembly
Attaching a pump drive wheel or functionally similar components to a component of the force-transmitting assembly
Attaching a closure cap or functionally similar components to a component of the force-transmitting assembly
Attaching a piston, in particular of multi-part pistons, to a component of the force-transmitting assembly.

The waved retaining ring can furthermore be used for axial fixation of a driving disk to a disk holder. By the provision of a waved retaining ring for this purpose, an axial motion of the driving disk within what is now a partial nonpositive connection with the disk holder is avoided. In addition, in the range of low torques, the axial prestressing prevents a motion in the circumferential direction within any play that may be present, because here again, because of frictional forces, for relatively low torques a nonpositive connection exists. Noise development in idling can thus be suppressed.

The waved retaining ring should be designed such that the resultant prestressing force is so great that the axial force always remains less than this prestressing force, because of the maximum rotary bending moment. Only by this means can “lifting” of the driving disk and thus also a relative motion in the axial direction be avoided. Moreover, the adhesion in the circumferential direction generated with the prestressing force can be great enough to prevent a motion of the driving disk in the circumferential direction during idling, especially at low torques. As a result, noise, such as idling rattling, is reliably prevented. Moreover, wear at the connection point is likewise prevented.

An optimal nonpositive-/positive-engagement connection between the driving disk and the disk holder is assured in that the driving disk is provided with an outer toothing, and the disk holder is provided with an inner toothing that in at least some portions is complementary in shape to the outer toothing of the driving disk. It is appropriate but not necessary for the inner toothing and the outer toothing, in the inserted state, to engage one another from behind at least in some portions.

It is especially advantageous if the waved retaining ring is braced on one side on the driving disk and on the other on the disk holder, preferably in a retaining ring groove in the disk holder. Since in some variant constructions of driver units, a retaining ring is already provided for axial fixation of the driving disk, it is advantageous to replace this conventional retaining ring with a resiliently embodied retaining ring that for instance is waved. With this kind of resilient retaining ring, relatively high prestressing forces can already be attained. In terms of assembly and logistics, the choice of a waved retaining ring as a means for axial prestressing produces a considerable advantage, since the previously necessary locking rings of graduated thicknesses can be replaced with a single waved ring. Depending on tolerance conditions, up to eleven different grades of thickness were necessary. This tolerance compensation is now achieved by a single waved ring inside the spring path.

The resilient property of the waved retaining ring has the advantage that the dynamic load on the retaining ring groove placed in the disk holder is at least reduced.

The invention is described in further detail below in conjunction with drawings, which show various exemplary embodiments.

Shown are:

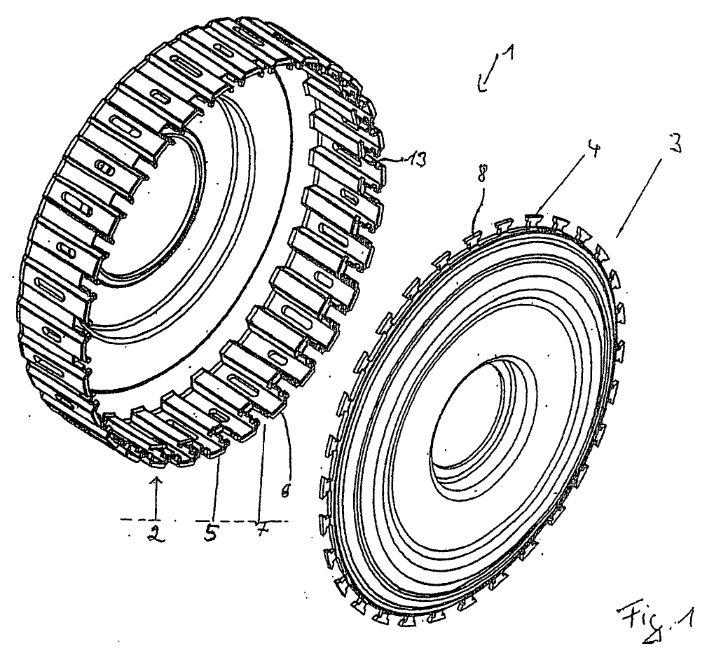

FIG. 1, a perspective view of a driving disk and an outer disk holder in the uninstalled state;

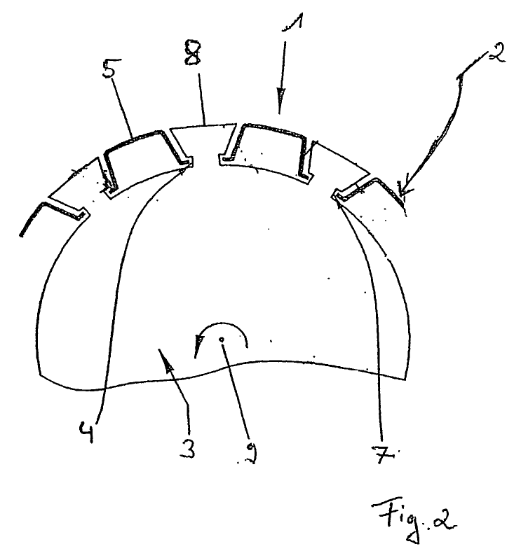

FIG. 2, a detail of a driver unit;

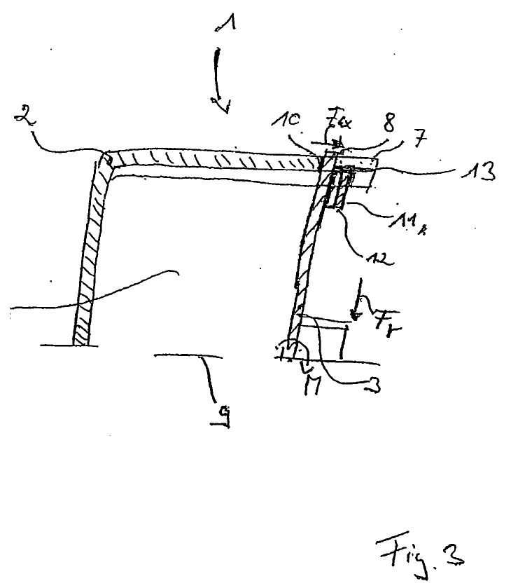

FIG. 3, a schematic illustration of a detail of a driver unit with a waved retaining ring;

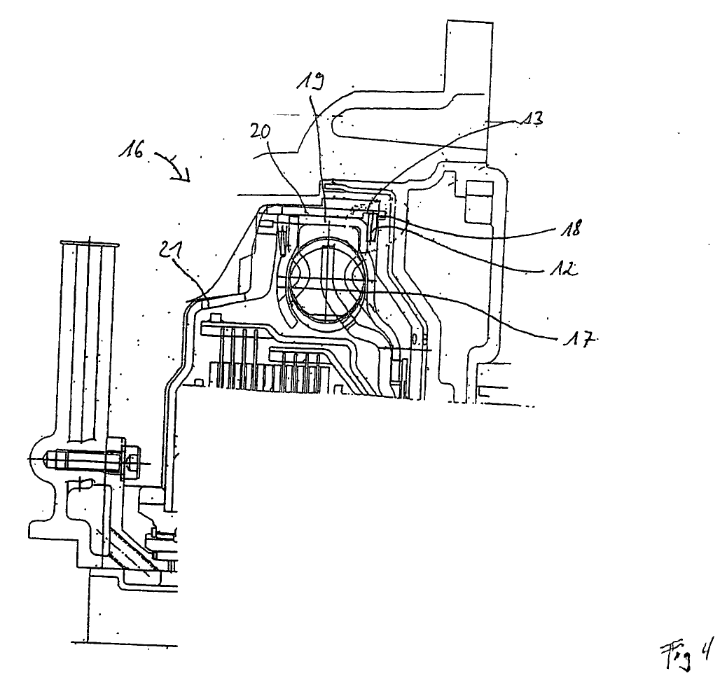

FIG. 4, a detail of a double multi-disk clutch assembly with a torsional vibration damper;

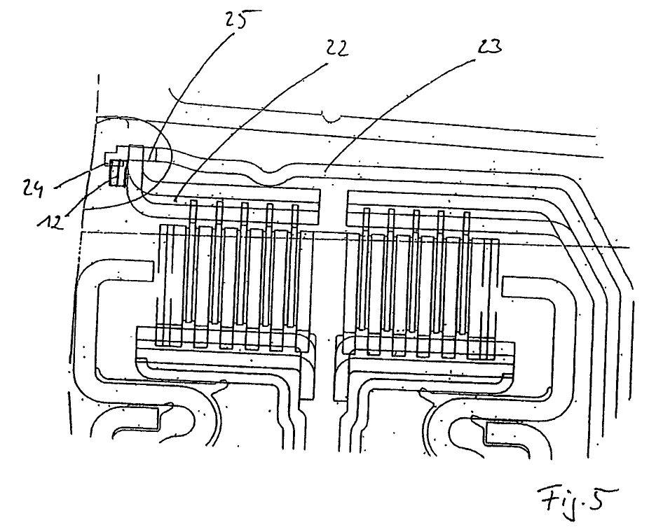

FIG. 5, a detail of another embodiment of a double multi-disk clutch assembly; and

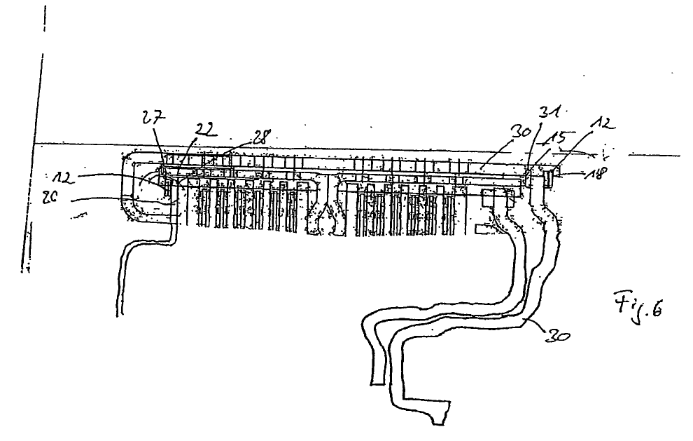

FIG. 6, a detail of still another embodiment of a double multi-disk clutch assembly.

In the drawings, identical components or components with the same function are identified by the same reference numerals.

FIG. 1 shows a driver unit 1 in perspective in a fragmentary view. In particular, FIG. 1 does not show any means for axially bracing the driving disk 3. All that are shown are a driving disk 3 and as an example an outer disk holder 2. The driving disk 3 is equipped with an outer toothing 4 extending all the way around. The outer disk holder 2 has an inner toothing 5. In the present exemplary embodiment, in the region of each tooth 6, the outer disk holder 2 has a slotlike recess 7, and in the installed state, a tooth 8 of the outer toothing 4 reaches through each slotlike recess. Because of the special embodiment of the teeth 8 and slotlike recesses 7, it is attained that the outer toothing 4 and inner toothing 5 engage one another from behind. It should be pointed out here that the embodiment shown of the positive-engagement connection between the driving disk and the disk holder is shown only as an example. The invention can also be achieved with connections that are embodied differently. For example, an outer toothing on the circumference of the driving disk 3 which is received in recesses of the disk holder suffices. A special engagement from behind, or for instance the provision of an inner toothing on the disk holder, is not absolutely necessary.

For reasons of simplicity, the axially displaceable friction plate that are provided in a known way in the disk holder have not been shown in any exemplary embodiment.

In FIG. 2, a driver unit is shown in the installed state, but once again no means for axially bracing the driving disk 3 have been shown. It becomes clear that the driving disk 3 and the disk holder 2 have a common pivot shaft 9 in the installed state. In the exemplary embodiment shown, the positive-engagement connection between the driving disk 3 and the outer disk holder 2 is formed by an outer toothing 4 on the driving disk 3 and by an inner toothing 5 on the disk holder 2; the teeth 8 of the outer toothing 4 engage slotlike recesses 7 of the disk holder 2. Especially in the case of the positive-engagement connection shown, the outer toothing 4 and inner toothing 5 engage one another from behind. As already noted, the waved nonpositive connection should be understood as only an example. In a substantially simpler embodiment, no inner toothing whatever is provided, and the outer toothing 4 is received in recesses in the disk holder 2.

FIG. 3 schematically shows a driver unit 1, comprising a disk holder 2 with outer disks not shown, and a driving disk 3 on the driving side. The driving disk 3 is connected circumferentially nonpositively to the outer disk holder 2. Teeth 8 of the driving disk 3 engage slotlike recesses 7 in the disk holder 2 here. The driving disk is braced in the axial direction on the end 10 of the slotlike recess 7 of the disk holder 2. On the opposite side, a circumferentially waved retaining ring 12 is provided for the axial prestressing. The waved retaining ring 12 is embodied as extending all the way around and is again braced on the disk holder 2 in a retaining ring groove 13. The retaining ring groove 13 is placed all the way around in the disk holder 2. In FIG. 1, a retaining ring groove 13 is shown for receiving a conventional retaining ring 15.

A radial force F_{R} produces a bending moment M. The radial force F_{R} can be ascribed for instance to an inexactly aligned installation of the force-transmitting assembly in the drive train. The bending moment M produces an axial force Fₐ, as a result of which the driving disk 3 might move in the axial direction. With the aid of the waved retaining ring for axial prestressing, the axial force Fₐ is compensated for. In the exemplary embodiment shown in FIG. 3, the axial tolerance compensation is also accomplished by means of the waved retaining ring 12. The waved retaining ring 12 should be designed such that the axial force Fₐ, because of the bending moment M, is always less than the prestressing force. Only in this way is “lifting” of the driving disk 3 prevented. Moreover, the frictional force generated with the prestressing force in the circumferential direction must be great enough, at least at low torques, to prevent a motion of the driving disk in the circumferential direction. From the standpoint of assembly and logistics, the use of a waved retaining ring 12 instead of flat retaining rings has a major advantage, since the previously required locking rings of graduated thickness can be replaced by a single, waved ring. Depending on the tolerance conditions, up to eleven different grades of thickness were necessary. This tolerance compensation is now accomplished by a single, waved ring within the spring path.

In FIG. 4, a double multi-disk clutch assembly 16, known per se, is shown along with a torsional vibration damper 17, likewise known per se. A shell 19 of the torsional vibration damper 17 is fixed in the axial direction on a housing part 20 of the double multi-disk clutch assembly 16 by means of a waved retaining ring 18. The waved retaining ring 12 is located in a retaining ring groove 13, made all the way around in the housing part 20, and protrudes radially inward past this groove. The waved retaining ring 12 is axially braced by one side on a groove wall 18 of the retaining ring groove 13. With its opposite side, the waved retaining ring 12 is braced axially on the outside of the shell 19 of the torsional vibration damper 17. The shell 19 and the housing part 20 are in turn braced axially on a further housing part 21. As a result of the provision of the waved retaining ring 12, the shell 19 of the torsional vibration damper 17 is prestressed axially against the further housing part 21.

In FIG. 5, a further embodiment of a double multi-disk clutch assembly 16, known per se, is shown. It is also shown that an outer disk holder 22 is prestressed axially against a shell-like housing part 23 by means of a waved retaining ring 12. The waved retaining ring 12 is braced on one side on a shoulder 24 of the housing part 23 and on the other on the disk holder 22. In toothing-like fashion, the disk holder radially engages axially extending recesses 25 in the housing part 23. By means of the waved retaining ring 23, the disk holder 22 is prestressed axially against the outer housing part 23.

In FIG. 6, a detail is shown of a further embodiment of a double multi-disk clutch assembly 16 that is known per se. It can be seen in the left half of the drawing that a closure cap 26 is prestressed axially against a disk holder 22 by means of a waved retaining ring 12 located in a retaining ring groove 13. The closure cap 26 radially engages axially extending recesses 27 in the disk holder 22 that are distributed over the circumference. The waved retaining ring 12 is axially braced on one side on a groove wall 18 and on the other on the closure cap 26, and as a result, the closure cap 26 is pressed axially against a bottom 28 of the recesses 27.

In the right half of the drawing in FIG. 6, the axial connection of a piston 29 to a housing part 30 is shown. The piston 29 reaches radially between a flat retaining ring 15 and a waved retaining ring 12. The flat retaining ring 15 is located in a groove 31 extending all the way around in the housing part 30. The waved retaining ring 12 is located in a retaining ring groove 13 and protrudes radially inward past this groove. The piston 29 is braced on one side on the flat retaining ring 15 and on the other on the waved retaining ring 12. The waved retaining ring 12 rests axially on a groove wall 18, so that the piston 29 is prestressed in the axial direction against the flat retaining ring 15. As a result, a play-free axial connection is obtained.

### LIST OF REFERENCE NUMERALS

1 Driver unit
2 Outer disk holder
3 Driving disk.
4 Outer toothing
5 Inner toothing
6 Teeth of the inner toothing
7 Slotlike recesses
8 Teeth of the outer toothing
9 Common pivot shaft
10 End of the recess
12 Waved retaining ring
13 Retaining ring groove
15 Retaining ring
16 Force-transmitting assembly (double multi-disk clutch assembly)
17 Torsional vibration damper
18 Groove wall
19 Shell
20 Housing part
21 Housing part
22 Outer disk holder
23 Shell-like housing part
24 Shoulder
25 Recess
26 Closure cap
27 Recesses
28 Bottom
29 Piston
30 Housing part
31 Groove
F_{R} Radial force
M Bending moment
Fₐ Axial force

1. A force-transmitting assembly, in particular a double multi-disk clutch assembly, comprising a plurality of components, and at least one waved retaining ring wherein at least two of said plurality of components are prestressed axially against one another by said at least one waved retaining ring.

2. The force-transmitting assembly as set forth in claim 1, wherein the waved retaining ring is braced in a retaining ring groove.

3. The force-transmitting assembly as set forth in claim 1 wherein the waved retaining ring is nondetachably joined to one of the components to be prestressed axially against one another.

4. The force-transmitting assembly as set forth in claim 1, further comprising a torsional vibration damper, wherein by way of the waved retaining ring, a said torsional vibration damper is prestressed axially against the force-transmitting assembly against a housing part of the force-transmitting assembly.

5. The force-transmitting assembly as set forth in claim 1, wherein by said at least one waved retaining ring, at least one disk holder is prestressed axially against a component.

6. The force-transmitting assembly as set forth in claim 1, wherein at least one pump drive wheel is prestressed axially against a component by said at least one waved retaining ring.

7. The force-transmitting assembly as set forth in claim 1, wherein at least one closure cap is prestressed axially against a component by said at least one waved retaining ring.

8. The force-transmitting assembly as set forth in claim 1, wherein at least one piston is prestressed axially against a component by said at least one waved retaining ring.

9. The force-transmitting assembly as set forth in claim 1, wherein by said at least one retaining ring, a driving disk is prestressed axially against a disk holder.

10. The force-transmitting assembly as set forth in claim 9, wherein a driving disk is provided with an outer toothing, and the disk holder is provided with an inner toothing such that at least some portions is complementary in shape to the outer toothing of the driving disk, and the driving disk is insertable into the disk holder.

11. The force-transmitting assembly as set forth in claim 9, wherein the waved retaining ring is braced on one side on the driving disk and on the other on the disk holder, in particular via a retaining ring provided in a retaining ring groove in the disk holder.

12. The force-transmitting assembly as set forth in claim 9, wherein the waved retaining ring is nondetachably joined to the driving disk.
